(19) United States
(12) Patent Application Publication
(10) Pub. No.: US 2026/0233700 A1
(43) Pub. Date: Aug. 13, 2026

(54) BATTERY ELECTRIC VEHICLES HAVING AN INPUT INTERFACE DISPOSED ALONG AN EXTERNAL SURFACE AND ACTIVATING AN ALERT STATE OF AN EMITTER

(71) Applicant: Toyota Motor Engineering & Manufacturing North America, Inc., Plano, TX (US)

(72) Inventor: Jennifer J. Angel, Manchester, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/047,966

(22) Filed: Feb. 7, 2025

(51) Int. Cl. B60R 25/10; B60L 53/66

(52) U.S. Cl. CPC B60R 25/1001; B60L 53/66; B60R 25/1003; B60L 2250/10; B60L 2270/36; B60R 2025/1016

(57) ABSTRACT

A battery electric vehicle includes a body having an external surface and a charge port disposed along the external surface and configured to couple to an electric power source for charging a battery of the battery electric vehicle. The battery electric vehicle further includes an emitter configured to emit a visual indicator and/or an auditory indicator around the battery electric vehicle when in an alert state. The battery electric vehicle further includes an input interface disposed along the external surface and in electronic communication with the emitter. The input interface is configured to be engaged by a user to activate the alert state of the emitter.

### TECHNICAL FIELD

The present specification generally relates to battery electric vehicles and, more specifically, battery electric vehicles having an input interface disposed along an external surface and configured to be engaged by a user to activate an alert state of an emitter.

### BACKGROUND

Many modern vehicles have a panic button on a key fob. During an emergency, the panic button may be activated causing the vehicle to flash lights and activate the horn. However, some vehicles, such as battery electric vehicles, do not use a physical key fob that could include a panic button. Rather, battery electric vehicles include an activation card that wakes the vehicle and when the vehicle senses the activation card allows the vehicle to be turned on. Electric charging stations are often placed in remote locations with no attendees with a large electrical box presenting a large visual obstruction. These factors in culmination in an unsafe environment in which the operator of the battery electric vehicle must be outside the vehicle for charging but without a way to activate the lights and horn in a way similar to the panic button.

Accordingly, a need exists for battery electric vehicles having an input interface disposed along an external surface and configured to be engaged by a user to activate an alert state of an emitter.

### SUMMARY

In one embodiment, a battery electric vehicle may include a body having an external surface, a charge port disposed along the external surface and configured to couple to an electric power source for charging a battery of the battery electric vehicle, an emitter configured to emit a visual indicator and/or an auditory indicator around the battery electric vehicle when in an alert state, and an input interface disposed along the external surface and in electronic communication with the emitter, the input interface configured to be engaged by a user to activate the alert state of the emitter.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of a battery electric vehicle having a charge port coupled to an electric charging station and a plurality of input interfaces disposed along an external surface of the battery electric vehicle, according to one or more embodiments shown and described herein;

FIG. 2 schematically depicts a perspective view of the charge port and one of the plurality of input interfaces of the battery electric vehicle, according to one or more embodiments shown and described herein; and

FIG. 3 schematically depicts a top plan view of the battery electric vehicle, according to one or more embodiments shown and described herein.

### DETAILED DESCRIPTION

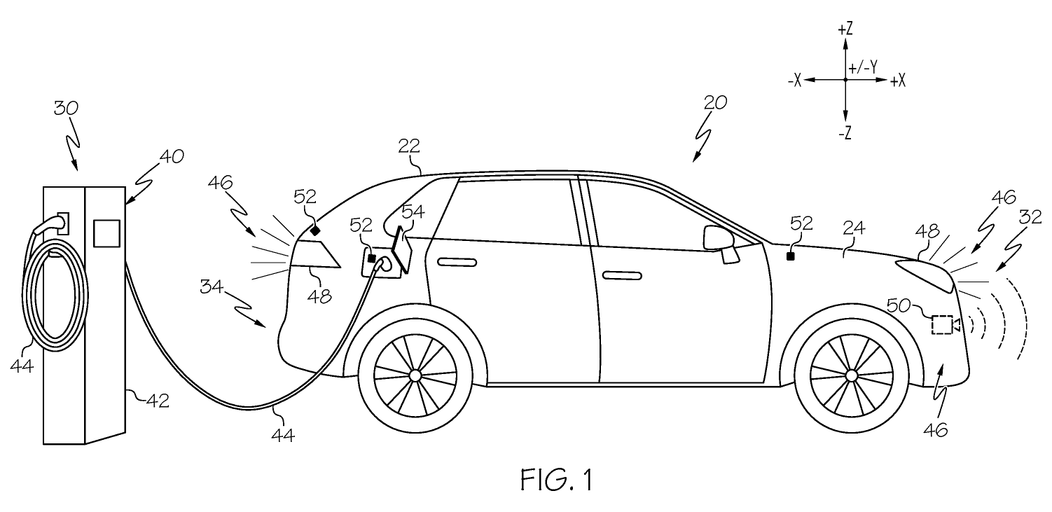

FIG. 1 generally depicts a battery electric vehicle. The battery electric vehicle includes a body having an external surface and a charge port disposed along the external surface and configured to couple to an electric power source for charging a battery of the battery electric vehicle. The battery electric vehicle further includes an emitter configured to emit a visual indicator and/or an auditory indicator around the battery electric vehicle when in an alert state. The battery electric vehicle further includes an input interface disposed along the external surface and in electronic communication with the emitter. The input interface is configured to be engaged by a user to activate the alert state of the emitter.

Previous vehicles have utilized panic button on a key fob that may be activated in an emergency, causing the vehicle to flash lights and activate the horn. However, battery electric vehicles often do not use a physical key fob that could include a panic button. Rather, battery electric vehicles include an activation card that wakes the vehicle and when the vehicle senses the activation card allows the vehicle to be turned on. Electric charging stations are often placed in remote locations with no attendees with a large electrical box presenting a large visual obstruction. These factors in culmination in an unsafe environment in which the operator of the battery electric vehicle must be outside the vehicle for charging but without a way to activate the lights and horn in a way similar to the panic button. The embodiments described herein overcome these limitations by including the input interface along the external surface of the battery electric vehicle, which may be engaged by a user to activate the alert state of the emitter. The input interface is accessible to the user when they are outside the vehicle, which adds to the safety of the user when performing tasks outside the vehicle, such as charging. Various embodiments and benefits of the battery electric vehicle will be described in more detail herein.

As used herein, the term “vehicle longitudinal direction” refers to the forward-rearward direction of the vehicle (i.e., in the +/- X direction of the coordinate axes depicted in FIG. 1). The term “vehicle lateral direction” refers to the cross-vehicle direction (i.e., in the +/- Y direction of the coordinate axes depicted in FIG. 1), and is transverse to the vehicle longitudinal direction. The term “vehicle vertical direction” refers to the upward-downward direction of the vehicle (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

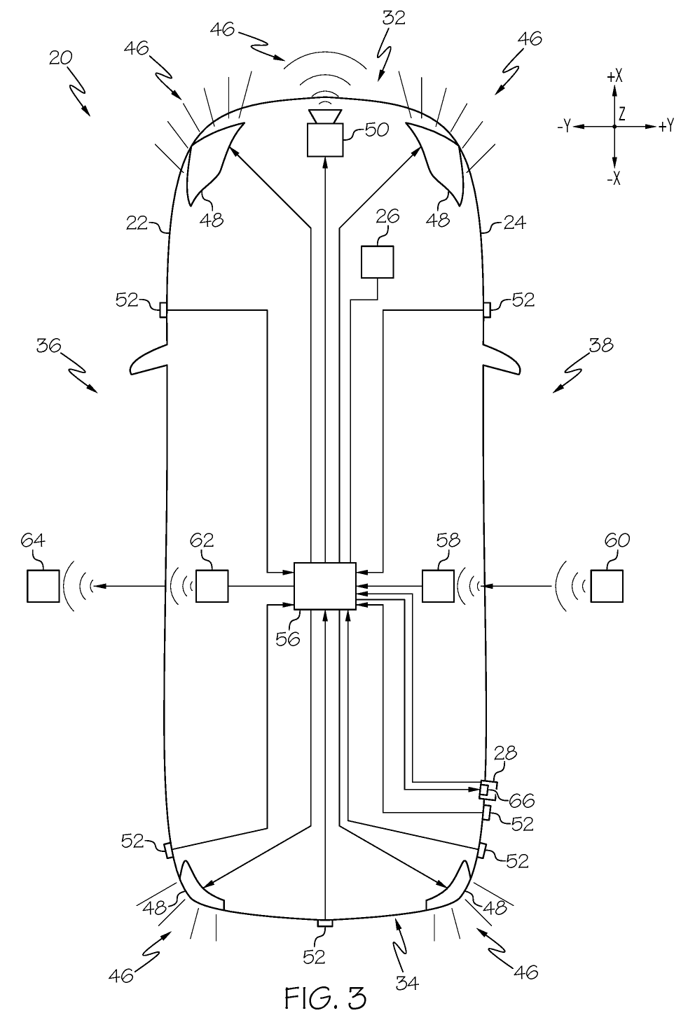

Referring now to FIG. 1, a battery electric vehicle 20 in accordance with one or more embodiments of the present disclosure is shown. The battery electric vehicle 20 may include a body 22 having an external surface 24. The body 22 may be formed from one or more of a body panel, chassis, a body-in-white, a window, a windshield, a door, a hatch, a trunk, etc. The battery electric vehicle 20 may further include a battery 26 mounted to the body 22, as shown in FIG. 3. The battery 26 is configured to store electrical energy for use by various components of the vehicle, including at least one electric motor that propels the vehicle by driving a plurality of wheels.

With reference to FIG. 3, the battery electric vehicle 20 may further include a charge port 28 disposed along the external surface 24 and configured to couple to an electric power source 30 for charging the battery 26 of the battery electric vehicle 20. As shown in the FIGS. 1-3, the body 22 may extend in the vehicle longitudinal direction X between a front end 32 and a rear end 34. Furthermore, the body 22 may extend in the vehicle lateral direction Y between a left side 36 and a right side 38 (see FIG. 3). The charge port 28 is disposed on the right side 38 of the vehicle adjacent the rear end 34. However, the charge port 28 may be positioned at any suitable location along the external surface 24 of the body 22 including the left side 36, the front end 32, and/or the rear end 34.

With reference to FIG. 3, the charge port 28 is electrically coupled to the battery 26. Therefore, the charge port 28 may transmits electricity received from the electric power source 30 to the battery 26. In the embodiment shown in FIG. 1, the electric power source 30 is an electric charging station 40 that may be found along a roadway used by the battery electric vehicle 20 for charging the battery 26. The electric charging station 40 may include a housing 42 configured to contain one or more of a transformer, a user interface, a user display, a pay terminal, etc. for operating the electric charging station 40. The electric charging station 40 may include a cable 44 mounted to and extending from the housing 42. The cable 44 is configured to engage and couple to the charge port 28. The cable 44 is transmits an electric current therethrough from the housing 42 to the charge port 28 for charging the battery 26 of the vehicle. While the electric power source 30 is shown as the electric charging station 40 in FIG. 1, the electric power source 30 may have any other suitable configuration, such as an electrical extension cord connected an electric circuit of a home.

With reference to FIG. 3, the battery electric vehicle 20 may further include an emitter 46. The emitter 46 may be activated into an alert state in which the emitter 46 emits a visual indicator and/or an auditory indicator around the battery electric vehicle 20. By emitting the visual indicator and/or the auditory indicator in the alert state, attention is drawn to the battery electric vehicle 20 and the user that may indicate an emergency that requires attention and aid.

With reference to FIGS. 1 and 3, the emitter 46 may include a plurality of external vehicle lights 48 that are configured to illuminate as the visual indicator. The plurality of external vehicle lights 48 may include one or more of a headlight, a tail light, a reverse indicator light, a daytime running lamp, an indicator light, a cargo light, etc. that may illuminated as the visual indicator. In the alert state, the plurality of external vehicle lights 48 may be activated in a repetitive (e.g., flashing), continuous, or any other suitable illumination pattern.

The emitter 46 may include a horn 50 configured to emit a sound as the auditory indicator. The horn 50 may emit the sound repetitively, continuously, or in any other suitable pattern. The horn 50 may be utilized for other purposes, such as to be actuated by the user during operation of the vehicle as an auditory warning or alert. In the alert state, the horn 50 may be activated in a repetitive, continuous, or any other suitable audio pattern. It is to be appreciated that the emitter 46 may include any component suitable for producing the visual indicator and/or the auditory indicator.

With continued reference to FIGS. 1 and 3, the battery electric vehicle 20 may further include a plurality of input interfaces 52 disposed along the external surface 24 and in electronic communication with the emitter 46. The plurality of input interfaces 52 are configured to be engaged by the user to activate the alert state of the emitter 46. In the embodiment shown in Figures, the plurality of input interfaces 52 is formed from six input interfaces 52 (see FIG. 3). However, any number of input interfaces 52 may be utilized. The plurality of input interfaces 52 may be independently engaged by the user to activate the alert state of the emitter 46. Said differently, by engaging one of the plurality of input interfaces 52 the user may activate the alert state of the emitter 46.

The plurality of input interfaces 52 may be spaced around the vehicle along the external surface 24. As shown in FIG. 3, two of the six input interfaces 52 are disposed along the left side 36 of the body 22 and three of the six input interfaces 52 are disposed along the right side 38 of the body 22. One of the six input interfaces 52 is disposed halfway between the left side 36 and the right side 38. Moreover, two the six input interfaces 52 are disposed adjacent the front end 32 of the body 22 and four of the six input interfaces 52 are disposed adjacent the rear end 34 of the body 22. It is be appreciated that the plurality of input interfaces 52 may be disposed in any suitable configuration about the body 22.

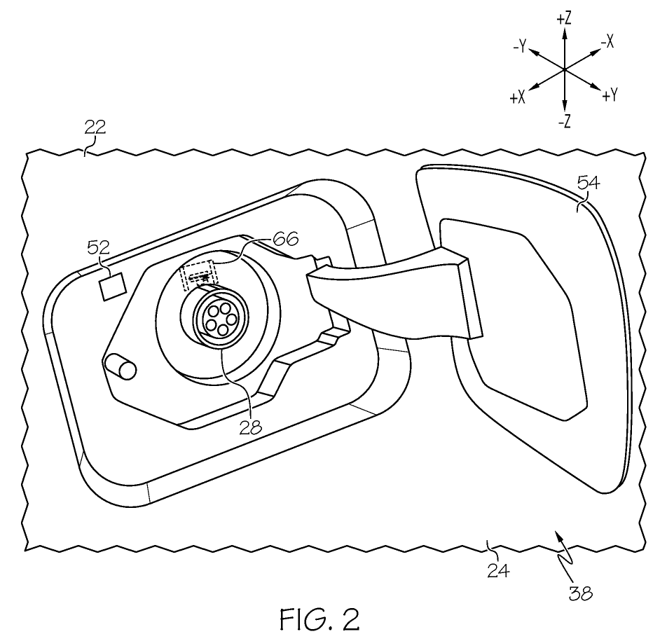

With reference to FIG. 2, one of the plurality of input interfaces 52 may be disposed adjacent the charge port 28. More specifically, the battery electric vehicle 20 may further include a lid 54 mounted to the body 22 and movable between a closed position covering the charge port 28 and an open position exposing the charge port 28. The input interface 52 disposed adjacent the charge port 28 is covered by the lid 54 in the closed position, which protects the input interface 52 from environment wear during operation but presents the input interface 52 for engagement by the user when the lid 54 is in the open position during charging.

One or more of the plurality of input interfaces 52 may be configured as a button that may be depressed by the user and correspondingly activate the alert state of the emitter 46 when the emitter 46 is an activated state. However, one or more of the plurality of input interfaces 52 may be configured as a toggle, switch, capacitive touch surface, or any other configuration suitable for activating the alert state of the emitter 46.

With reference to FIG. 3, the battery electric vehicle 20 may further include an electronic control unit 56 in communication with the emitter 46 and the input interface 52. The electronic control unit 56 may include a processor and a memory unit coupled to the processor. The processor may include processing components operable to receive and execute instructions from the memory unit. The memory unit may store detection logic and control logic. The detection logic and the control logic may each include a plurality of different pieces of logic, each of which may be embodied as a computer program, firmware, and/or software/hardware. In some embodiments, the memory unit is configured as volatile and/or nonvolatile memory and as such may include random access memory (SRAM, DRAM, and/or other types of RAM), flash memory, secure digital (SD) memory, registers, compact discs, digital versatile discs (DVD), and/or other types of nontransitory computer readable mediums. Depending on the particular embodiments, these nontransitory computer readable mediums may reside within the electronic control unit 56 and/or external to the electronic control unit 56.

The electronic control unit 56 is configured to receive an input signal from the input interface 52 when engaged by the user. The electronic control unit 56 correspondingly transmits an output signal that is received by the emitter 46 to activate to place the emitter 46 in the activated state. As described above, the emitter 46 may include numerous components, including the plurality of external vehicle lights 48 and the horn 50. Therefore, the electronic control unit 56 may transmit the output signal to each of the plurality of external vehicle lights 48 and the horn 50. In other embodiments, the electronic control unit 56 may selectively transmit the output signal to one or more of the plurality of external vehicle lights 48 and the horn 50.

With continued reference to FIG. 3, the battery electric vehicle 20 may further include a receiver 58 in communication with the electronic control unit 56. Furthermore, the battery electric vehicle 20 may include an activation module 60 configured to move with the user and be detected by the receiver 58. The activation module 60 is configured to be detected by the receiver 58 when the activation module 60 is within a predetermined distance of the receiver 58 such that a signal output by the activation module 60 is received by the receiver 58 and the electronic control unit 56 places the emitter 46 in the activated state. In some embodiments, the receiver 58 is a transceiver that outputs a signal that is received by the activation module 60, the activation module 60 outputs a response signal in response to receiving the signal from the receiver 58 such that the electronic control unit 56 places the emitter 46 in the activated state. The activation module 60 may include a mobile terminal, an activation card, a fob, a smart phone having an application, or any other suitable component that may be detected by the receiver 58. In one example, the activation module 60 being within the predetermined distance of the receiver 58 is being within a ten foot radius of the receiver 58. In another example, the activation module 60 being within the predetermined distance of the receiver 58 is being within a 20 foot radius of the receiver 58. In yet another example, the activation module 60 being within the predetermined distance of the receiver 58 is being within a 50 foot radius of the receiver 58. It is to be appreciated that the activation module 60 may be in proximity of the receiver 58 based on any suitable distance or detection shape/pattern.

The electronic control unit 56 may place the emitter 46 in the activated state when the receiver 58 detects that the activation module 60 is within the predetermined distance of the receiver 58. The emitter 46 is prohibited from emitting the visual indicator and/or the auditory indicator when not in the activated state. As such, the activation of the input interfaces 52 does not place the emitter in the alert state unless the emitter is in the activated state which requires that the activation module 60 is within the predetermined distance of the receiver 58. Therefore, the electronic control unit 56 may reduce the occurrence of inadvertent, malicious, or otherwise undesired engagement of the input interface 52 causing activation of the alert state of the emitter 46 by tying the activation to when the operator is presumed to be within the predetermined distance of the input interface 52.

With continued reference to FIG. 3, the battery electric vehicle 20 may further include a transmitter 62 in communication with the electronic control unit 56. The transmitter 62 may be configured to establish wireless communication with an external receiver 64 outside of the battery electric vehicle 20. The wireless communication may performed through a cellular network, a satellite network, a Wi-Fi network, a radio network, or any other suitable wireless communication protocol. The external receiver 64 may be automated or human operated. The transmitter 62 is configured to receive the output signal from the electronic control unit 56 and send a request for emergency services to the external receiver 64. Therefore, the transmitter 62 may enlarge the effective range of the emitter 46 outside of a vicinity of the vehicle by indicating to emergency services that assistance is needed at the battery electric vehicle 20.

With reference to FIG. 2, the battery electric vehicle 20 may further include a latch 66 adjacent the charge port 28 and configured engage and retain engagement the electric power source 30 (see FIG. 1) with the charge port 28. The latch 66 may retain engagement the electric power source 30 with the charge port 28 to reduce the occurrence of inadvertent, malicious, or otherwise undesired disengagement of the electric power source 30 from the charge port 28, which would stop the battery 26 from receiving a charge. The latch 66 may be configured to receive the output signal from the electronic control unit 56 and disengage the electric power source 30 to allow removal from the charge port 28. Therefore, the latch 66 may be disengaged by the user engaging the input interface 52 and thus allow for quick, unencumbered removal of the electric power source 30 from the charge port 28 in an emergency situation. In doing so, the user is aided in the ability to quickly get into the battery electric vehicle 20 for protection and/or to flee the area.

With reference to FIG. 3, the electronic control unit 56 may be configured to perform variations of the output signal based upon variations in the input signal received from the input interface 52. For example, in one embodiment the user may engage (e.g., press) the input interface 52 once to activate the alert state of the emitter 46. The user may then choose to perform a second engagement of the input interface 52 that disengages the latch 66, allow removal of the electric power source 30 from the charge port 28. The user may then choose to perform a third engagement of the input interface 52 that causes the transmitter 62 to send the request for emergency services to the external receiver 64. Therefore, the user may be able to select a desired effect by engaging the input interface 52 depending on the situation the user has encountered. It is to be appreciated that the electronic control unit 56 may be configured to perform any variations of the output signal based upon any variations in the input signal received from the input interface 52.

In order for the user to initiate the emitter 46 to emit the visual indicator and/or the auditory indicator, the activation module 60 is within the predetermined distance of the receiver 58 which places the emitter 46 in the activated state. Once the emitter 46 is in the activated state, the activation of the input interface 52 places the emitter 46 in the alert state to emit the visual indicator and/or the auditory indicator, and/or cause the transmitter 62 to send the request for emergency services to the external receiver 64.

It should now be understood that embodiments of the present disclosure are directed to a battery electric vehicle. The battery electric vehicle includes a body having an external surface and a charge port disposed along the external surface and configured to couple to an electric power source for charging a battery of the battery electric vehicle. The battery electric vehicle further includes an emitter configured to emit a visual indicator and/or an auditory indicator around the battery electric vehicle when in an alert state. The battery electric vehicle further includes an input interface disposed along the external surface and in electronic communication with the emitter. The input interface is configured to be engaged by a user to activate the alert state of the emitter. The disposition of the input interface along the external surface makes the input interface accessible to the user when they are outside the vehicle, which adds to the safety of the user when performing tasks outside the vehicle, such as charging.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A battery electric vehicle comprising:
a body having an external surface;
a charge port disposed along the external surface and configured to couple to an electric power source for charging a battery of the battery electric vehicle;
an emitter configured to emit a visual indicator and/or an auditory indicator around the battery electric vehicle when in an alert state; and
an input interface disposed along the external surface and in electronic communication with the emitter, the input interface configured to be engaged by a user to activate the alert state of the emitter.

2. The battery electric vehicle of claim 1, wherein the input interface is disposed adjacent the charge port.

3. The battery electric vehicle of claim 1, wherein the external body includes a lid mounted to the body and movable between a closed position covering the charge port and an open position exposing the charge port, the input interface covered by the lid in the closed position.

4. The battery electric vehicle of claim 1, further comprising an electronic control unit in communication with the emitter and the input interface, the electronic control unit configured to receive an input signal from the input interface when engaged by the user and correspondingly transmit an output signal that is received by the emitter to activate the alert state of the emitter.

5. The battery electric vehicle of claim 4, further comprising a receiver in communication with the electronic control unit and an activation module configured to move with the user and be detected by the receiver when within a predetermined distance of the receiver, the electronic control unit transmitting an activation signal to place the emitter in an activated state when the receiver detects that the activation module is in within the predetermined distance of the receiver,
wherein the input interface only activates the alert state of the emitter when the emitter is in the activation state.

6. The battery electric vehicle of claim 4, further comprising a transmitter in communication with the electronic control unit and configured to establish wireless communication with an external receiver outside of the battery electric vehicle, the transmitter configured to receive the output signal from the electronic control unit and send a request for emergency services to the external receiver.

7. The battery electric vehicle of claim 4, further comprising a latch adjacent the charge port and configured engage and retain engagement the electric power source with the charge port, the latch configured to receive the output signal from the electronic control unit and disengage the electric power source to allow removal from the charge port.

8. The battery electric vehicle of claim 1, wherein the input interface is a button.

9. The battery electric vehicle of claim 1, wherein the emitter comprises a horn configured to emit a sound as the auditory indicator.

10. The battery electric vehicle of claim 1, wherein the emitter comprises a plurality of external vehicle lights that are configured to illuminate as the visual indicator.
